(19) United States
(12) Patent Application Publication
(10) Pub. No.: US 2023/0057557 A1
(43) Pub. Date: Feb. 23, 2023

(54) SILIRANE COMPOUNDS AS STABLE SILYLENE PRECURSORS AND THEIR USE IN THE CATALYST-FREE PREPARATION OF SILOXANES

(71) Applicant: WACKER CHEMIE AG, Munich (DE)

(72) Inventors: Richard WEIDNER, Burghausen (DE); Fabian Andreas David Herz, Berg (DE); Matthias Fabian NOBIS, Munich (DE); Bernhard RIEGER, Elchingen (DE)

(73) Assignee: Wacker Chemie AG, Munich (DE)

(21) Appl. No.: 17/781,838

(22) PCT Filed: Dec. 4, 2019
(86) PCT No.: PCT/EP2019/083744

§ 371 Date: Jun. 2, 2022

(51) Int. Cl. C07F 7/08; C08G 77/16; C07F 7/10; C07F 7/18

(52) U.S. Cl. CPC C07F 7/0807; C08G 77/16; C07F 7/10; C07F 7/18

(57) ABSTRACT

A silirane-functionalized compound that consists of a substrate to which a least two silirane groups of the formula (1) are covalently bonded, a mixture containing the silirane-functionalized compounds, and a process for preparing siloxanes using the mixture are described herein.

The invention describes silirane-functionalized compounds consisting of a substrate on which at least two silirane groups of the formula (I) are covalently bonded, and also a mixture comprising the silirane-functionalized compounds of the invention, and a process for preparing siloxanes. The crosslinking occurs through the thermal activation of polyfunctional siliranes, which represent a stable precursor for highly reactive silylene species. The formation of a network is accomplished here through the reaction of the silylenes with functionalized siloxanes or polysiloxanes, and enables the use of a broad spectrum of common siloxane compounds.

### PRIOR ART AND TECHNICAL OBJECT

Silicones are of great interest on account of their outstanding chemical and physical properties and are therefore employed diversely. In contrast to the situation with carbon-based plastics, the van der Waals forces between homopolymer chains are very weak in the case of siloxanes. In siloxane homopolymers this leads to flow behavior and very poor properties, even at very high molecular weights. For this reason, siloxanes are crosslinked and so acquire their rubber-elastic condition.

There are a number of known processes for crosslinking siloxanes, with a fundamental distinction made between addition crosslinking, condensation crosslinking, and radical crosslinking. In the case of addition crosslinking, vinyl-functionalized siloxanes react with hydridosiloxanes without elimination products in a process referred to as hydrosilylation (RTV-2 or HTV). The reaction requires the use of noble metal catalysts (usually platinum), which cannot be recovered. In the case of condensation crosslinking, terminal silanol groups are reacted with other silicon-functional groups (e.g. Si—O—CH₃, Si—O—C₂H₅, Si—O—COCH₃). The reaction is accompanied by the elimination of small, volatile compounds such as acetic acid or alcohols, for example, and hence also by a physical contraction. Condensation-crosslinking systems may be operated as one-component systems, activated by contact with small amounts of water (RTV-I). The mixtures are usually admixed with a metal catalyst (e.g., tin-based) to accelerate the crosslinking reaction. In the case of radical crosslinking, organic peroxides are employed which on heating break down into radicals (HTV). The reactive radicals crosslink vinyl methyl siloxanes, for example.

Whereas in the processes stated the high reactivity is brought about by catalysts, the crosslinking method described here is based on the extraordinarily high reactivity of silylenes. Silylenes are charge-free divalent silicon compounds and hence the heavier homologues of the carbenes. On account of their diverse reactivity, silylene compounds are suitable for crosslinking a wide variety of different monomers. With Si—H compounds, for example, silylenes react in an insertion reaction, forming a disilane. The reaction with nucleophiles such as silanols or alcohols, for example, is likewise accomplished through insertion into the O—H bond. The insertion of a silylene into the Si—O bond of an alkoxy silane forms a disilane. With alkenes and alkynes, silylenes enter into a cycloaddition reaction to form silacyclopropanes (silirane) or silacyclopropenes (silirene), respectively.

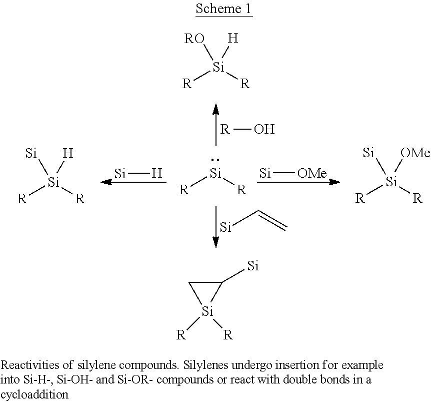

There are a number of known methods for the synthesis of silylenes. The decomposition of polysilanes by UV light or heat yields, for example, highly reactive silylenes such as Me₂Si, which are not stable and quickly dimerize. Since the polysilanes are prepared under very harsh conditions, this synthesis method leaves little room for maneuver in the choice of the functional groups. More complex silylenes are accessible through the reduction of dihalosilanes. Reducing agents used may be lithium or KCs, for example. There are silylene compounds known which have thermodynamically and kinetically stabilizing groups, which are certainly stable at room temperature. Because the reactivity therefore goes down as the stability of the silylenes increases, highly stabilized silylenes are less suitable as a functional group for the linking of siloxanes. The costly and inconvenient stabilization by means of complex ligands would also be too costly and inconvenient in industrial quantities. In the case of the siloxane linking method described here, therefore, precursors rather than silylenes are used, the precursors being convertible into silylenes by external influences. Particularly suitable for this purpose are silirane compounds, which by means of appropriate activation, by thermolysis or photolysis, for example, can be cleaved into silylene and olefin. The driving force of the dissociation is the high ring tension of the siliranes. Silirane compounds are significantly more stable than their silylene analogues and may be regarded as masked silylenes. The stability of the siliranes, or the requisite decomposition temperature, may be controlled by their functionalization. Siliranes are additionally able to react with nucleophilic compounds, such as alcohols, for example, in a ring-opening reaction. As this is an addition reaction, there is no elimination product in this case. Through the use of siliranes in the linking of siloxanes, they are compatible, therefore, with a very broad spectrum of functional groups. Siliranes are generally very reactive owing to the high ring tension in the cyclic structure.

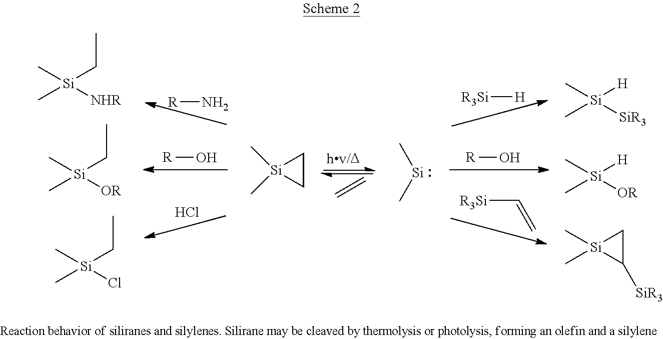

In Macromolecules 2003, 36, 1474-1479 it was shown that monofunctional siliranes can be polymerized anionically.

Semenov et al., in (a) Russian Journal of Applied Chemistry 2002, 75 (1), 127-134, (b) Russian Chemical Reviews 2011, 80 (4), 3313-339, and (c) Applied Organometallic Chemistry 1990, 4, 163-172, describe oligodimethylsilanes as a source of photochemically generated silylenes for the crosslinking of silanol-terminated vinylmethylsiloxanes. The crosslinking takes place by the formation of a silirane by the highly reactive silylene with a vinyl group, the silirane being able subsequently to react with a silanol group. The siliranes formed were not detected during a crosslinking, and the correctness of the mechanism is therefore questionable. Moreover, owing to the low UV penetration, the method is possible only with very low film thicknesses (˜100 μm film).

Known from Journal of Organometallic Chemistry 2011, 696, 1957-1963, moreover, are the following difunctional bis-silirane compounds:

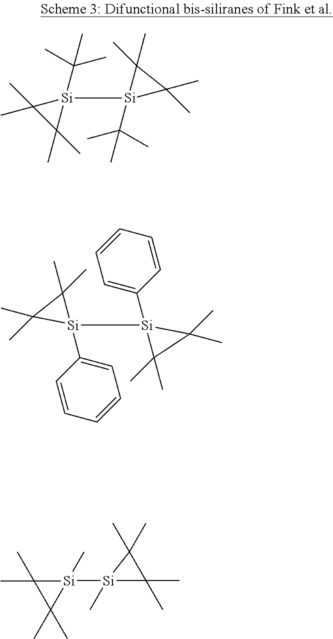

Additionally it is known from WO2015/088901 that monosiliranes can be used for the surface functionalization of substrates which are terminated with OH groups, NH₂ groups or NH groups.

Stabilized bis-silylenes (cf. Scheme 4) are likewise known from the literature (Angew. Chem. Int Ed. 2009, 48, 8536-8538 and J. Am. Chem. Soc. 2010, 132, 15890-15892), but their use in the polymer chemistry sector is not described.

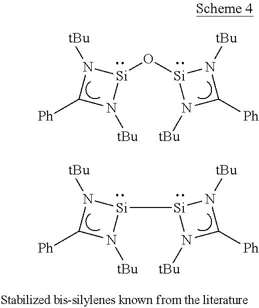

Only US2002/0042489A1 discloses the use of heterocyclic silylenes as catalysts for the polymerization of alkenes or alkynes.

### Technical Achievement

A subject of the invention are silirane-functionalized compounds consisting of a substrate on which at least two silirane groups of the formula (I)

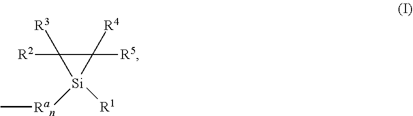

are covalently bonded,
where in formula (I) the index n adopts a value of 0 or 1;
and where the radical R^{a} is a divalent C₁-C₂₀ hydrocarbon radical;
and where the radical R¹ is selected from the group consisting of (i) C₁-C₂₀ hydrocarbon radical, (ii) C₁-C₂₀ hydrocarbonoxy radical, (iii) silyl radical —SiR^{a}R^{b}R^{c}, in which the radicals R^{a},R^{b},R^{c} independently of one another are a C₁-C₆ hydrocarbon radical, (iv) amine radical —NR^{x}₂, in which the radicals R^{x} independently of one another are selected from the group consisting of (iv.i) hydrogen, (iv.ii) C₁-C₂₀ hydrocarbon radical, and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; and where the radicals R²,R³,R⁴,R⁵ independently of one another are selected from the group consisting of (i) hydrogen, (ii) halogen, and (iii) C₁-C₂₀ hydrocarbon radical, in which the radicals R² and R⁴ may also be part of a cyclic radical.

The substrate is preferably selected from the group consisting of organosilicon compounds, hydrocarbons, silicas, glass, sand, stone, metals, semimetals, metal oxides, mixed metal oxides, and carbon-based oligomers and polymers.

The substrate is more preferably selected from the group consisting of silanes, siloxanes, precipitated silica, fumed silica, glass, hydrocarbons, polyolefins, acrylates, polyacrylates, polyvinyl acetates, polyurethanes and polyethers composed of propylene oxide and/or ethylene oxide units.

One particular embodiment of the invention are silirane-functionalized organosilicon compounds of the general formula (II)

(SiO_{4/2})ₐ(R^{x}SiO_{3/2})_{b}(R′SiO_{3/2})_{b′}(R^{x}₂SiO_{2/2})_{c}(R^{x}R′SiO_{2/2})_{c′}(R′₂SiO_{2/2})_{c″}(R^{x}₃SiO_{1/2})_{d}(R′R^{x}₂SiO_{1/2})_{d′}(R′₂R^{x}SiO_{1/2})_{d″}(R′₃SiO_{1/2})_{d″′} (II),

in which the radicals R^{x} independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical;
and in which the indices a, b, b′, c, c′, c″, d, d′, d″, d″′ indicate the number of the respective siloxane unit in the compound and independently of one another are an integer in the range from 0 to 100 000, with the proviso that the sum of a, b, b′, c, c′, c″, d, d′, d″, d″′ together adopts a value of at least 2 and at least one of the indices b′, c′, d′ is ≥2 or at least one of the indices c″, d″ or d″′ is other than 0; and the radicals R′ are a silirane group of the formula (IIa)

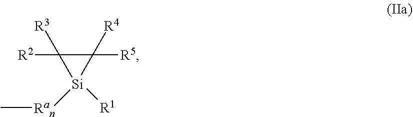

in which the index n adopts a value of 0 or 1; and
in which the radical R^{a} is a divalent C₁-C₂₀ hydrocarbon radical; and where the radical R¹ is selected from the group consisting of (i) C₁-C₂₀ hydrocarbon radical, (ii) C₁-C₂₀ hydrocarbonoxy radical, (iii) silyl radical —SiR^{a}R^{b}R^{c}, in which the radicals R^{a},R^{b},R^{c} independently of one another are a C₁-C₆ hydrocarbon radical, (iv) amine radical —NR^{x}₂, in which the radicals R^{X} independently of one another are selected from the group consisting of (iv.i) hydrogen, (iv.ii) C₁-C₆ hydrocarbon radical, and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; and where the radicals R²,R³,R⁴,R⁵ independently of one another are selected from the group consisting of (i) hydrogen, (ii) halogen, and (iii) C₁-C₂₀ hydrocarbon radical, in which the radicals R² and R⁴ may also be part of a cyclic radical.

The arrangement of the silicon atoms in the silirane-functionalized compounds is of elemental significance. It is absolutely necessary for the silicon atoms to be connected to one another via a core scaffold. In this way, after activation of the silirane-functionalized compound, a crosslinkable compound with multiple silylene group is obtained. If the silicon atoms are not bridged with one another, the activation of the siliranes generates free “monosilylenes” and polyfunctional vinyl compounds. These free monosilylenes are incapable of crosslinking, and react with the functional groups of the siloxanes (compare scheme 6).

In formula (IIa) the radical R^{a} is preferably a C₁-C₃ alkylene radical. More preferably the radical R^{a} is an ethylene radical.

By way of the substituent R¹ on the silicon atom of a silirane it is possible, through kinetic and thermodynamic control, to exert influence over the reactivity and stability of the silirane-functionalized compounds. In formula (IIa) the radical R¹ is preferably selected from the group consisting of (i) C₁-C₆ hydrocarbon radical and (ii) amine radical —N(SiR^{a}R^{b}R^{c})₂, in which the radicals R^{a},R^{b},R^{c} independently of one another are a C₁-C₆ hydrocarbon radical. In formula (IIa) the radical R¹ is more preferably selected from the group consisting (i) C₁-C₆ alkyl radical and (ii) —N(SiMe₃)₂.

In formula (IIa) the radicals R²,R³,R⁴,R⁵ independently of one another are preferably selected from the group consisting of (i) hydrogen and (ii) C₁-C₆ alkyl radical, in which the radicals R² and R⁴ as well may be part of a cyclic radical. In formula (IIa) the radicals R²,R³,R⁴,R⁵ independently of one another are more preferably selected from the group consisting of (i) hydrogen and (ii) C₁-C₆ alkyl radical, in which the radicals R² and R⁴ as well may be part of a hexenyl radical.

One preferred embodiment are silirane-functionalized compounds where in formula (II) the indices a, b, b′, c, c′, c″, d, d″ and d″′ adopt a value of 0 and the index d′ adopts a value of 2; and where in formula (IIa) the index n adopts a value of 1; and the radical R^{a} is a C₁-C₃ alkylene radical; and the radical R¹ is selected from the group consisting of (i) C₁-C₆ hydrocarbon radical and (ii) amine radical —N(SiR^{a}R^{b}R^{c})₂, in which the radicals R^{a},R^{b},R^{c} independently of one another are a C₁-C₆ hydrocarbon radical; and the radicals R²,R³,R⁴,R⁵ independently of one another are selected from the group consisting of (i) hydrogen and (ii) C₁-C₆ alkyl radical, in which the radicals R² and R⁴ may also be part of a cyclic radical.

Another preferred embodiment are silirane-functionalized compounds where in formula (II) the indices a, b, b′, c, c′, c″, d, d″ and d′″ adopt a value of 0 and the index d′ adopts a value of 2; and where in formula (IIa) the index n adopts a value of 1; and the radical R^{a} is an ethylene radical; and the radical R¹ is selected from the group consisting of (i) C₁-C₆ alkyl radical and (ii) —N(SiMe₃)₂; and the radicals R²,R³,R⁴,R⁵ independently of one another are selected from the group consisting of (i) hydrogen and (ii) C₁-C₆ alkyl radical, in which the radicals R² and R⁴ may also be part of a hexenyl radical.

Particularly preferred examples of the silirane-functionalized compounds of the invention are the compounds SV1, SV2 and SV3 set out in scheme 5.

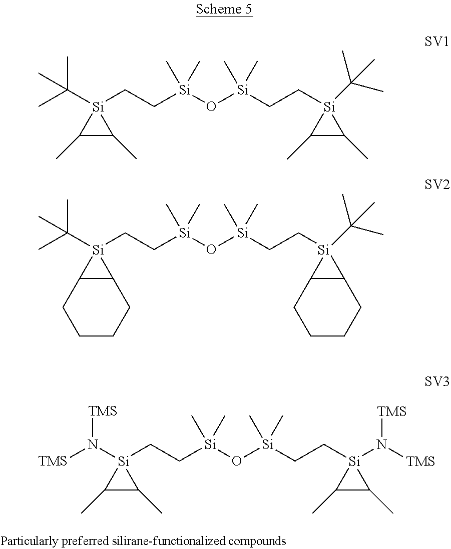

The silirane-functionalized organosilicon compounds are synthesized for example by reduction of dihalosilanes with reducing agents such as lithium or potassium graphite in polar coordinating solvents (e.g., tetrahydrofuran). Reduction of the dihalosilane groups form intermediate silylenes, which are scavenged with olefin compounds and react to form a silirane.

As the olefin compound for scavenging the silylenes it is possible generally to employ all compounds having a double bond. Because the substituents on the silirane ring critically influence the reactivity, the choice of the olefin may also be used to exert an influence over the behavior of the silirane-functionalized organosilicon compound. During the activation of the silirane-functionalized organosilicon compounds, the siliranes are cleaved back into silylene and olefin. It is therefore an advantage to choose an olefinic compound which under the reaction conditions of a conversion reaction is gaseous and is able to volatilize.

Alternatively the silirane-functionalized compounds may also be prepared via a Wurtz coupling, in which the C—C bond of the silirane ring is formed.

Another subject of the invention is a mixture comprising

a) at least one silirane-functionalized compound of the invention; and
b) at least one compound A which has in each case at least two radicals R′, where the radicals R′ independently of one another are selected from the group consisting of (i) —Si—H, (ii) —OH, (iii) —CₓH₂ₓ—OH, in which x is an integer in the range of 1-20, (iv) —CₓH₂ₓ—NH₂, in which x is an integer in the range of 1-20, (v) —SH, and (vi) —R^{a}ₙ—CR═CR₂, in which R^{a} is a divalent C₁-C₂₀ hydrocarbon radical and the index n adopts a value of 0 or 1 and the radicals R independently of one another are selected from the group consisting of (vi.i) hydrogen and (vi.ii) C₁-C₆ hydrocarbon radical.

One particular embodiment of the invention is a mixture where the compound A is selected from functionalized siloxanes of the general formula (III)

(SiO_{4/2})ₐ(R^{x}SiO_{3/2})_{b}(R′SiO_{3/2})_{b′}(R^{x}₂SiO_{2/2})_{c}(R^{x}R′SiO_{2/2})_{c′}(R′₂SiO_{2/2})_{c″}(R^{x}₃SiO_{1/2})_{d}(R′R^{x}₂SiO_{1/2})_{d′}(R′₂R^{x}SiO_{1/2})_{d″}(R′₃SiO_{1/2})_{d″′} (III),

in which the radicals R^{x} independently of one another are selected from the group consisting of (i) halogen, and (ii) unsubstituted or substituted C₁-C₂₀ hydrocarbon radical; and
in which the radicals R′ independently of one another are selected from the group consisting of (i) hydrogen, (ii) —OH, (iii) —CₓH₂ₓ—OH, in which x is an integer in the range of 1-20, (iv) —CₓH₂ₓ—NH₂, in which x is an integer in the range of 1-20, (v) —SH, and (vi) —R^{a}ₙ—CR═CR₂, in which R^{a} is a divalent C₁-C₂₀ hydrocarbon radical and the index n adopts a value of 0 or 1 and the radicals R independently of one another are selected from the group consisting of (i) hydrogen and (ii) C₁-C₆ hydrocarbon radical, and
in which the indices a, b, b′, c, c′, c″, d, d′, d″, d″′ indicate the number of the respective siloxane unit in the compound and independently of one another are an integer in the range from 0 to 100 000, with the proviso that the sum of a, b, b′, c, c′, c″, d, d′, d″, d″′ together adopts a value of at least 2 and at least one of the indices b′, c′, d′ is 2 or at least one of the indices c″, d″ or d″′ is other than 0.

The silirane-functionalized compounds of the invention are stable precursors of the highly reactive silylenes. A silylene group is formed from each silirane group only after activation of the crosslinker. The silirane-functionalized compounds of the invention must therefore possess at least two silirane groups in order to be able to function as crosslinkers.

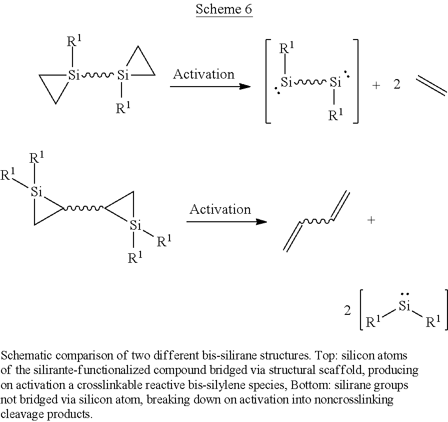

A further subject of the invention is a process for producing siloxanes, comprising the following steps:

(i) providing a mixture according to the invention in accordance with the particular embodiment, and
(ii) reacting the mixture by thermal, photochemical or catalytic activation.

The linking of a mixture of the functionalized siloxane of the formula (III) and of a silirane-functionalized compound of the invention may be achieved through thermal, photochemical or catalytic activation. In the linking procedure the silirane units of the organosilicon compound react to form silylenes, which then react with the functional groups of the siloxane, which they crosslink.

There are various ways in which the silirane-functionalized compounds of the invention may be activated (that is, the siliranes converted into silylenes). Thermal activation requires a temperature above the decomposition temperature of the silirane compound. Silirane compounds may also be converted into siliranes by photochemical activation. The wavelength required for this purpose is in the UV range. The reactivity of the siliranes is identical with both activation methods. Furthermore, catalysts may also be used to accelerate the linking reaction or for room-temperature crosslinking. Suitable catalysts are compounds which destabilize siliranes and so bring about cleavage into silylene and olefin. Examples of such catalysts are AgOTf and Cu(OTf)₂. Generally the activation of the siliranes also produces olefinic compounds (e.g., 2-butene).

Owing to the high reactivity, the activated silirane-functionalized compounds are able to react with a wide spectrum of functional groups. Possible reaction partners are, for example, Si—H, Si—OR, Si—OH, C—OH, —NH₂, S—H and -vinyl. Consequently all common functional groups of industrial siloxanes are supported. The functionalized siloxanes must have at least two of the stated functional groups for a network to be formed. The mechanism of the crosslinking of a difunctional siloxane with a silirane compound is that each insertion of the resultant silylene forms a new group which can be attacked and hence forms a nodal point.

Also possible are different functionalities on a (poly)siloxane (e.g., Si—OH terminated, methylvinyl groups in the chain). Because of the difference in reactivity (cycloaddition), vinyl-substituted (poly)siloxanes must possess at least three vinyl groups.

The properties of the crosslinked polymer may be modified through the length and/or molecular mass of the functionalized siloxanes. The method of silylene linkage may be carried out both with low molecular mass and with high molecular mass functionalized siloxanes. Examples of functionalized siloxane compounds are set out in scheme 7.

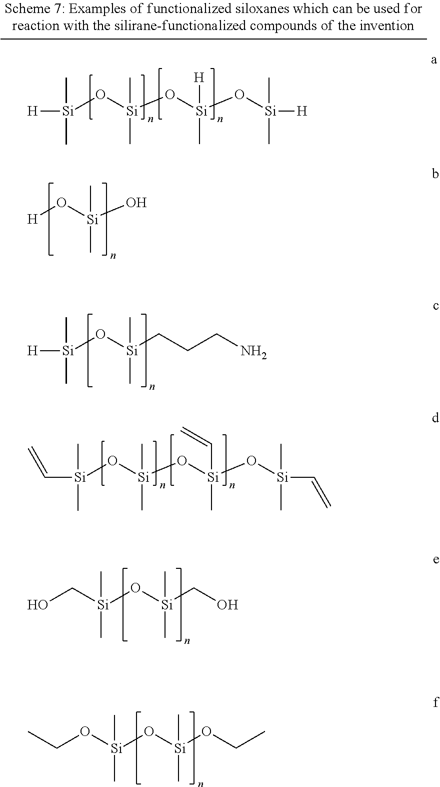

The reaction of the silylenes with the functional groups of the siloxane is accomplished by insertion of the silylene into the functional groups. The reaction of a silylene with hydridosiloxanes and alkoxysiloxanes produces disilane bonds between the silirane-functionalized compound and siloxane. These disilanes have newly formed Si—H or Si—OR groups, which represent a further point of attack for silylenes. Each reaction of a silylene with the siloxane, accordingly, produces a further attachable functional group. Nucleophilic functional groups such as silanols, alcohols and amines react with silylene likewise through insertion of the silylene into the functional group. In this case no disilanes are formed; instead, siloxanes and silazanes are formed, which also have a newly formed Si—H functionality for further crosslinking. Through the formation of new points of attach during the reaction it is possible to use siloxanes having only two functional groups as well.

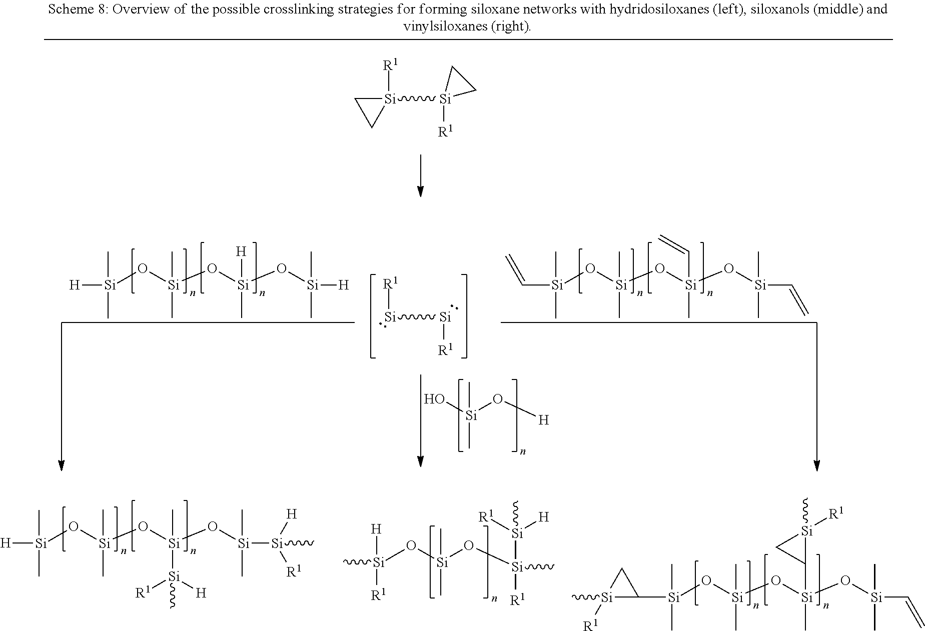

For preparation of siloxanes, the silirane-functionalized compound of the invention and the functionalized siloxane of the formula (III) are mixed until homogeneous mixing is ensured. The linking takes place only through the activation of the mixture by means of one of the three methods stated above. The mixture is activated until the silirane-functional compound of the invention has been fully consumed by reaction, or until the desired properties have been achieved. A successful crosslinking procedure is likewise possible. In the case of silirane-functionalized compounds that are sensitive to air, inert gas or other appropriate measures must be used to prevent contact with oxygen and water.

The temperature in the reaction is chosen such that it lies above the decomposition temperature of the silirane-functionalized compound, this being the formation of silylenes by thermolysis. Customarily the temperature is in a range of 60-200° C., preferably in a range of 80-150° C., more preferably in a range of 130-150° C.

The silirane-functionalized compound is mixed with the functionalized siloxane of the formula (III) in a suitable molar ratio. Customarily the molar ratio of silirane groups to functional groups in the siloxane is in a range of 4:1-1:4, preferably in a range of 1:1-1:4.

### EXAMPLES

All syntheses were carried out under Schlenk conditions in baked glass apparatus. Argon or nitrogen was used as inert gas. Chemicals used (vinylsilanes, vinylsiloxanes, silicone oils, etc.) were acquired from WACKER Chemie AG, from ABCR or from Sigma-Aldrich. Cis-2-butene (2.0) and trans-2-butene (2.0) were acquired from Linde AG. All of the solvents were dried and distilled before being used. All of the silicone oils were dried over Al₂O₃ and 3 Å molecular sieve and degassed before being used. The molecular weights are reported as average values and are based on manufacturer figures. The polysiloxanes used are random copolymers. All of the chemicals used were stored under inert gas. Lithium with 2.5% sodium fraction was obtained by melting elemental lithium (Sigma-Aldrich, 99%, trace metal basis) and sodium (Sigma-Aldrich, 99.8%, sodium basis) at 200° C. in a nickel crucible under an argon atmosphere. Before being used, the Li/Na alloy was cut into extremely small pieces in order to increase the surface area. Al₂O₃ (neutral) and activated carbon were dried under a high vacuum at 150° C. for 72 hours.

Magnetic resonance spectroscopy (¹H, ²⁹Si) was carried out using a Bruker Avance III 500 MHz.

Mass spectrometry was carried out using LIFDI-MS 700 with an ion source from Linden CMS.

Elemental analyses were carried out by the microanalytical laboratory of the Faculty of Chemistry at Munich Technical University using a Vario EL from Elementar.

### Synthesis example 1: preparation of 1,3-bis(2-(1-(tert-butyl)-2,3-dimethylsiliran-1-yl)ethyl)-1,1,3,3-tetramethyldisiloxane (SV1)

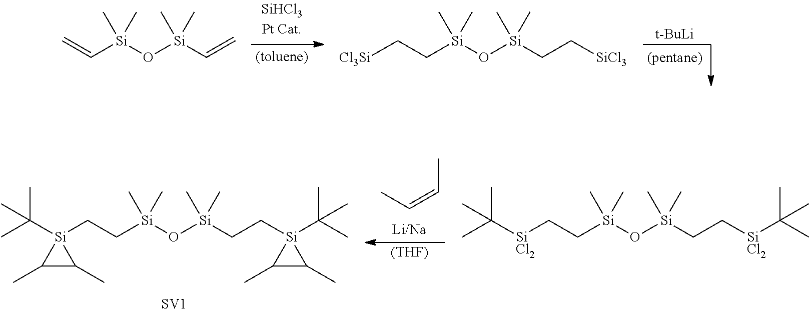

The bis-silirane SV1 is synthesized via a three-step reaction pathway, beginning with the starting compound divinyltetramethyldisiloxane. In the first synthesis step this compound is reacted via a hydrosilylation reaction with trichlorosilane in the presence of the Karstedt catalyst (platinum(0)-1,3-divinyl-1,1,3,3-tetramethyldisiloxane complex). For this reaction, 100 g (740 mmol, 4.0 equivalents) of trichlorosilane are introduced into 30 mL of toluene in a 250 mL Schlenk flask and mixed with 34.4 g (180 mmol, 1.0 equivalent) of divinyltetramethyldisiloxane. Then 0.05 mL of Karstedt catalyst (2.1-2.4% Pt in xylene) is added to the reaction mixture, 10 which is stirred at room temperature for 18 hours. After the end of the reaction, the mixture is filtered through dried neutral aluminum oxide and residual solvent is removed under reduced pressure. This gives 81.3 g (96%, 177 mmol) of the product (Cl₃SiCH₂CH₂SiMe₂)₂O as a clear, colorless liquid.

¹H-NMR: (294 K, 500 MHz, C₆D₆) δ=0.10 (s, 12H, CH₃), 0.55-0.60 (in, 4H, CH₂), 1.05-1.10 (in, 4H, CH₂).

²⁹Si-NMR: (294 K, 500 MHz, C₆D₆) δ=8.14 (SiO), 13.84 (SiCl₃).

EA [%]: calculated: C=21.01, H=4.41. found: C=20.93, H=4.63.

The next synthesis step takes place via the substitution of the hexachlorosilane with tert-butyllithium. For this reaction, 30.0 g (65.6 mmol, 1.0 equivalent) of (Cl₃SiCH₂CH₂SiMe₂)₂O are dissolved in 75 mL of pentane and the solution is cooled to −10° C. Via a dropping funnel 8.40 g (131 mmol, 2.0 equivalents) 1.7 M tert-butyllithium solution are slowly added dropwise. The reaction is then heated to 0° C. and stirred for 8 hours. Lithium chloride formed is removed by filtration and the filtrate is separated from the solvent under reduced pressure. A subsequent sublimination of the crude product under high vacuum (110° C., 10-5 mbar) affords 22.0 g (67%, 43.9 mmol) of the tetrachlorosilane (Cl₂tBuSiCH₂CH₂SiMe₂)₂O as a white solid.

¹H-NMR: (294 K, 500 MHz, C₆D₆) 6=0.05 (s, 12H, Si—CH₃), 0.78-0.82 (m, 4H, CH₂), 1.00 (s, 18H, SiC—CH₃), 1.04-1.08 (m, 4H, CH₂).

²⁹Si-NMR: (294 K, 500 MHz, C₆D₆) 6=8.22 (Si—O), 38.47 (Si-tBuCl₂).

EA [%]: calculated: C=38.39, H=7.65. found: C=38.25, H=7.76.

The last step of the synthesis of the bis-silirane involves the reduction of the tetrachlorosilane by means of a lithium-sodium alloy (2.5% Na). For this reaction step, 10.0 g (20.0 mmol, 1.0 equivalent) of tetrachlorosilane (Cl₂tBuSiCH₂CH₂SiMe₂)₂O are dissolved in 50 mL of THF. The reaction solution is cooled to −30° C., after which 33.6 g (600 mmol, 30.0 equivalents) of cis-butene are incorporated by condensation. In an argon countercurrent 2.10 g (300 mmol, 15.0 equivalents) of a lithium-sodium alloy (2.5% Na) are added and the reaction solution is stirred vigorously at room temperature for 7 days. When the reduction of the chlorosilane is at an end, the solvent is removed under reduced pressure and the residue is taken up in pentane. Precipitated lithium salt is removed by filtration and the filtrate is again dried under reduced pressure. This gives 7.80 g (86%, 16.7 mmol) of the bis-silirane SV1 as a yellowish oil. In view of the purity of the cis-butene gas used (purity 2.0), the trans and the 1-butene species are found alongside the cis species.

### Trans Species:

¹H-NMR: (294 K, 500 MHz, C₆D₆) 6=0.12-0.14 (m, 12H, Si—CH₃), 0.46-0.52 (m, 4H, Si CH₂), 0.74-0.78 (m, 4H, Si—CH₂), 1.12 (s, 18H, SiC—CH₃), (m, 4H, Si—CH), 1.43-1.45 (m, 12H, SiCH—CH₃).

²⁹Si-NMR: (294 K, 500 MHz, C₆D₆) 6=−53.11 (CH—Si—CH), 8.01 (Si—O).

### Cis Species:

¹H-NMR: (294 K, 500 MHz, C₆D₆) 6=0.14-0.16 (m, 12H, Si—CH₃), 0.86-0.88 (m, 8H, CH₂), 1.03 (s, 18H, SiC—CH₃), 1.08-1.11 (m, 4H, Si—CH), 1.43-1.45 (m, 12H, SiCH—CH₃).

²⁹Si-NMR: (294 K, 500 MHz, C₆D₆) 6=−49.70 (CH—Si—CH), 7.30 (Si—O).

### 1-Butene Species:

¹H-NMR: (294 K, 500 MHz, C₆D₆) 6=0.07-0.10 (m, 12H, Si—CH₃), 0.59-0.68 (m, 4H, Si—CH₂), 0.79-0.81 (m, 4H, Si—CH₂), 1.08 (s, 18H, SiC—CH₃), 1.18-1.19 (m, 2H, CH₂Si—CH—CH₂CH₃), 1.19-1.20 (m, 4H, CHSi—CH₂), 1.39-1.40 (m, 4H, SiCH—CH₂—CH₃), 1.47-1.49 (m, 6H, SiCHCH₂—CH₃).

²⁹Si-NMR: (294 K, 500 MHz, C₆D₆) 6=−42.34 (CH₂—Si—CH), 6.89 (Si—O).

EA [%]: calculated: C=61.20, H=11.56. found: C=58.13, H=11.31.

LIFDI-MS: (THF) m/z=471.95 [M]⁺, 415.99 [M-C₄H₈]⁺, 360.01 [M-C₈H₁₆]⁺.

Since the three stated bis-siliranes are stereoisomers, they have the same molecular mass. They are therefore indistinguishable in the mass spectrum. The same is true of the results of the elemental analysis.

### Synthesis example 2: preparation of 1,3-bis(2-(7-(tert-butyl)-7-silabicyclo[4.1.0]heptan-7-yl)ethyl)-1,1,3,3-tetramethyldisiloxane (SV2)

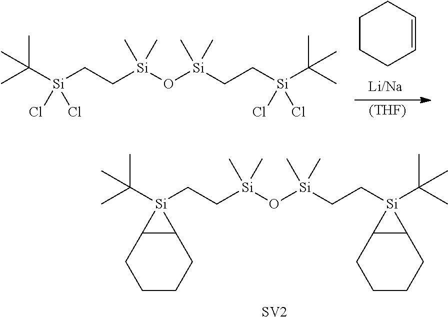

The tetrachlorosilane (Cl₂tBuSiCH₂CH₂SiMe₂)₂O, which represents the starting compound in this synthesis is prepared by a route analogous to that in synthesis example 1. For the subsequent reduction, 1.00 g (2.00 mmol, 1.0 equivalent) of tetrachlorosilane is mixed with 3.94 g (47.9 mmol, 24.0 equivalents) of cyclohexene in 2.5 mL of THF. The reaction solution is admixed with 208 mg (29.9 mmol, 25.0 equivalents) of a lithium-sodium alloy (2.5% Na) and stirred vigorously at room temperature for 10 hours. When reduction of all the chlorosilanes is completed, the solvent and excess cyclohexene are removed under reduced pressure, and the residue is resuspended again in 5 mL of pentane. Precipitated LiCl is removed and the filtrate is dried under reduced pressure. This gives 382 mg (37%, 0.73 mmol) of the bis-silirane SV2 as a clear oil. A cis and a trans species of the bis-silirane SV2 are obtained.

### Cis Species:

¹H-NMR: (294 K, 500 MHz, C₆D₆) δ=0.13-0.15 (m, 12H, Si—CH₃), 0.90 (m, 8H, Si—CH₂), 1.03 (s, 18H, SiC—CH₃), 1.49-1.54 (m, 8H, SiCHCH₂—CH₂), 1.71-1.78 (m, 8H, SiCH—CH₂), 1.98-2.05 (m, 4H, Si—CH).

²⁹Si-NMR: (294 K, 500 MHz, C₆D₆) δ=−49.09 (Si—CH), 7.27 (Si—O).

### Trans Species:

¹H-NMR: (294 K, 500 MHz, C₆D₆) δ=0.12-0.13 (m, 12H, Si—CH₃), 0.47-0.52 (m, 4H, Si—CH₂), 0.77-0.81 (m, 4H, Si—CH₂), 1.15 (s, 18H, SiC—CH₃), 1.64-1.67 (m, 4H, Si—CH), 1.78-1.83 (m, 8H, SiCHCH₂—CH₂), 1.88-1.97 (m, 8H, SiCH—CH₂).

²⁹Si-NMR: (294 K, 500 MHz, C₆D₆) δ=−53.75 (Si—CH), 7.89 (Si—O).

### Synthesis example 3: preparation of 1,3-bis(2-(7-(tert-butyl)-7-silabicyclo[4.1.0]heptan-7-yl)ethyl)-1,1,3,3-tetramethyldisiloxane (SV3)

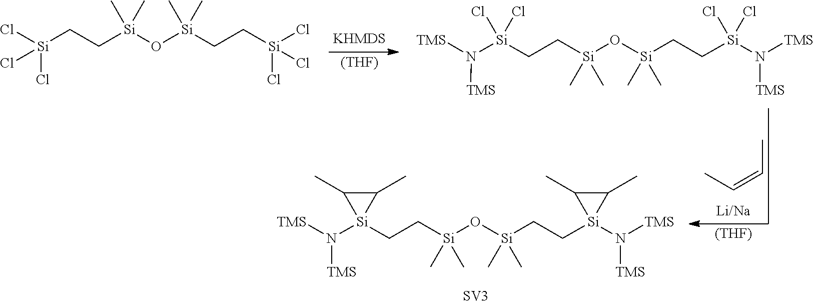

The bis-silirane SV3 is prepared via a two-step synthesis from the corresponding hexachlorosilane. In the first step 10.0 g (21.9 mmol, 1.0 equivalent) of (Cl₃SiCH₂CH₂SiMe₂)₂O are introduced into 40 mL of THE and cooled to 0° C. Then a solution of 8.72 g (43.7 mmol, 2.0 equivalents) of potassium-hexamethyldisilazane (KHMDS) in 30 ml of THE is added slowly dropwise over a period of 30 minutes. The resulting suspension is stirred at room temperature for 6 hours. The solvent is then removed under reduced pressure. The residue is taken up in 40 mL of pentane, followed by filtration. Removal of the solvent again under reduced pressure gives 12.5 g (81%, 17.7 mmol) of (TMS₂NCl₂SiCH₂CH₂SiMe₂)₂O as a clear, yellowish liquid.

¹H-NMR: (294 K, 500 MHz, C₆D₆) δ=0.07 (s, 12H, OSi—CH₃), 0.33 (s, 36H, NSi—CH₃), 0.83-0.87 (m, 4H, OSi—CH₂), 1.25-1.29 (m, 4H, NSi—CH₂).

²⁹Si-NMR: (294 K, 500 MHz, C₆D₆) δ=2.19 (Si—C₁₂), 6.38 (Si-Mes), 8.45 (Si—O).

EA [%]: calculated: C=33.97, H=07.98, N=03.96. found: C=33.39, H=07.96, N=03.94.

The subsequent reaction step involves the reduction of a tetrachlorosilane to give the corresponding bis-silirane. For this reaction, 10.0 g (14.2 mmol, 1.0 equivalent) of (TMS₂NCl₂SiCH₂CH₂SiMe₂)₂O are dissolved in 50 mL of THE and the reaction mixture is conditioned to −30° C. Then 23.10 g (424 mmol, 30.0 equivalents) of cis-butene are introduced into the reaction vessel by condensation, and 1.47 g (212 mmol, 15.0 equivalents) of lithium-sodium alloy (2.5% Na) are added in an argon countercurrent. The reaction mixture is warmed to room temperature and stirred for 5 days. Following the complete reduction of the chlorosilane, the solvent is removed under reduced pressure and the residue is resuspended in 30 mL of pentane. Precipitated lithium chloride is separated off and the product solution is filtered through dried neutral aluminum oxide. The filtrate is subsequently dried under reduced pressure, to give 5.46 g (57%, 8.06 mmol) of a cis/trans mixture and also the corresponding bis-silirane SV3 from the 1-butene species, as a yellowish, turbid oil.

### Cis Species:

¹H-NMR: (294 K, 500 MHz, C₆D₆) δ=0.12-0.13 (m, 12H, OSi—CH₃), 0.22 (s, 36H, NSiCH₃), 0.77-0.80 (m, 8H, CH₂), 1.12-1.15 (m, 4H, Si—CH), 1.19-1.21 (m, 12H, CH—CH₃).

²⁹Si-NMR: (294 K, 500 MHz, C₆D₆) δ=−50.01 (CH—Si—CH), 4.71 (N—Si-TMS), 7.81 (Si—O).

### Trans Species:

¹H-NMR: (294 K, 500 MHz, C₆D₆) δ=0.11-0.12 (m, 12H, Si—CH₃), 0.25-0.26 (m, 36H, NSiCH₃), 0.47-0.52 (m, 4H, CH₂), 0.81-0.85 (m, 4H, CH₂), 1.17-1.18 (m, 4H, Si—CH), 1.27-1.30 (m, 12H, CH—CH₃).

²⁹Si-NMR: (294 K, 500 MHz, C₆D₆) δ=−44.90 (CH—Si—CH), 4.70 (N—Si-TMS), 7.68 (Si—O).

### 1-Butene Species:

¹H-NMR: (294 K, 500 MHz, C₆D₆) δ=0.09-0.10 (m, 12H, Si—CH₃), 0.23-0.24 (m, 36H, NSiCH₃), 0.52-0.57 (m, 4H, SiCH₂), 0.67-0.71 (m, 4H, SiCH₂), 0.93-0.99 (m, 4H, SiCH—CH₂), 1.27 (m, 2H, CH₂Si—CH), 1.34-1.35 (m, 6H, SiCHCH₂—CH₃).

²⁹Si-NMR: (294 K, 500 MHz, C₆D₆) δ=−41.12 (CH—Si—CH), 5.31 (N—Si-TMS), 7.86 (Si—O).

EA [%]: calculated: C=49.63, H=10.71, N=4.13. found: C=47.34, H=10.60, N=3.98.

LIFDI-MS: (THF) m/z=675.69 [M]⁺, 619.75 [M-C₄H₈]⁺, 564.25 [M-C₈H₁₆]⁺, 244.06 [M-C₂₀H₅₂N₂Si₄]⁺.

### Use Example 1: Crosslinkinq of Hydridomethylsiloxane-Dimethylsiloxane Copolymer with SV1

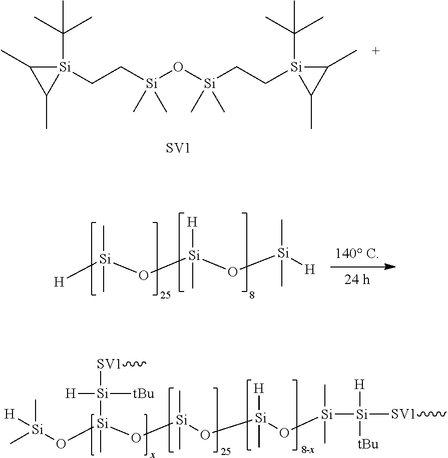

SV1 (100 mg, 212.3 μmol, 1.0 equivalent) and silicone oil (254 mg, 106.2 μmol, 0.5 equivalent, 2.395 g/mol, (25-30% methylhydridosiloxane-dimethylsiloxane copolymer, Si—H terminated)) are weighed out in a molar ratio of 1:2 (silirane groups to Si—H groups) under inert gas into a suitable vessel. The mixture is taken up in 0.5 mL of pentane and stirred with a magnetic stirring bar until homogeneous mixing is ensured. The pentane is then removed again under reduced pressure. Crosslinking takes place at 140° C. under inert gas for 24 hours. The product is a slightly turbid, colorless and slightly elastic polymer which is not sticky. Owing to the short chain length of the siloxane, the material is fairly brittle and ruptures under tensile load. The polymer swells significantly in benzene and does not dissolve. No soluble constituents were detectable by NMR spectroscopy. The butene formed in the crosslinking is perceptible through the characteristic odor.

### Use Example 2: Crosslinking of Hydridomethylsiloxane-Dimethylsiloxane Copolymer with SV3

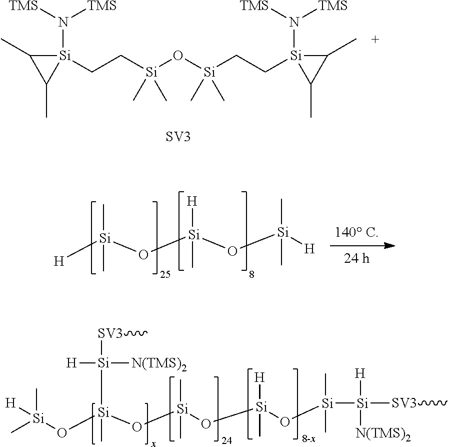

SV3 (100 mg, 147.6 μmol, 1.0 equivalent) and silicone oil (233 mg, 97.4 μmol, 0.66 equivalent, 2.395 g/mol, (25-30% methylhydridosiloxane-dimethylsiloxane copolymer, Si—H terminated)) are weighed out in a molar ratio of 1:3 (silirane groups to Si—H groups) under inert gas into a suitable vessel. The mixture is stirred with a magnetic stirring bar until homogeneous mixing is ensured. Crosslinking takes place at 140° C. under inert gas for 24 hours. The product is a clear, slightly yellowish and slightly elastic polymer which is not sticky. Owing to the short chain length of the siloxane, the material is fairly brittle and ruptures under tensile load. The polymer swells significantly in benzene and does not dissolve. No soluble constituents were detectable by NMR spectroscopy.

### Use Example 3: Crosslinking of Hydridomethylsiloxane-Dimethylsiloxane Copolymer with SV3

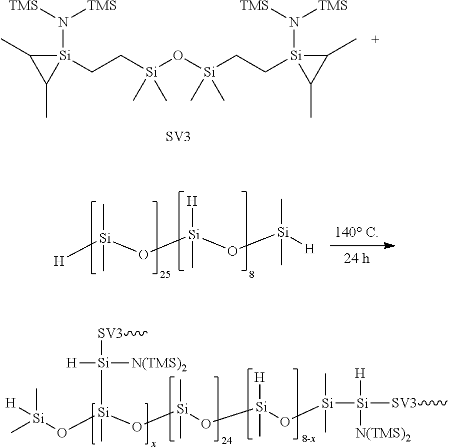

SV3 (100 mg, 147.6 μmol, 1.0 equivalent) and silicone oil (78 mg, 32.5 μmol, 0.22 equivalent, 2.395 g/mol, (25-30% methylhydridosiloxane-dimethylsiloxane copolymer, Si—H terminated)) are weighed out in a molar ratio of 9:10 (silirane groups to Si—H groups) under inert gas into a suitable vessel. The mixture is stirred with a magnetic stirring bar until homogeneous mixing is ensured. Crosslinking takes place at 140° C. under inert gas for 24 hours. The product is a clear, slightly yellowish and slightly elastic polymer which is not sticky. Owing to the short chain length of the siloxane, the material is fairly hard and brittle and ruptures under tensile load. The polymer swells significantly in benzene and does not dissolve. No soluble constituents were detectable by NMR spectroscopy. Because of the higher silirane fraction, the polymer is significantly more solid than in the case of use example 2.

### Use Example 4: Inert Gas-Free Crosslinking of Hydridomethylsiloxane-Dimethylsiloxane Copolymer with SV3

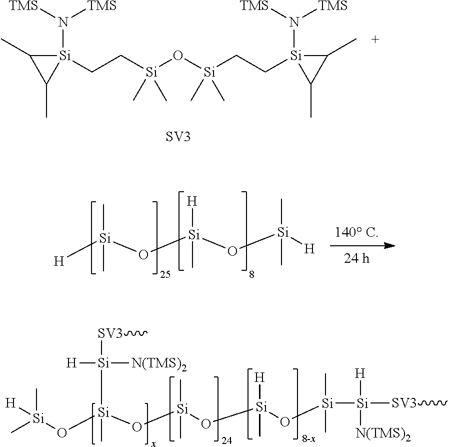

SV3 (100 mg, 147.6 μmol, 1.0 equivalent) and silicone oil (78 mg, 32.5 μmol, 0.22 equivalent, 2.395 g/mol, (25-30% methylhydridosiloxane-dimethylsiloxane copolymer, Si—H terminated)) are weighed out in a molar ratio of 9:10 (Silirane groups to Si—H groups) under inert gas into a suitable vessel. The mixture is stirred with a magnetic stirring bar in air until homogeneous mixing is ensured. Crosslinking takes place at 140° C. in air for 24 hours. The product is a clear, slightly yellowish and slightly elastic polymer which is not sticky. The material exhibits properties analogous to those of the described elastomer from the use example 3. Oxygen and moisture from the ambient air have no recognizable effect on the crosslinking of the polymer. The bis-silirane SV3 is therefore sufficiently stable with respect to air.

### Use Example 5: Crosslinking of Hydridomethylsiloxane-Dimethylsiloxane Copolymer with SV1

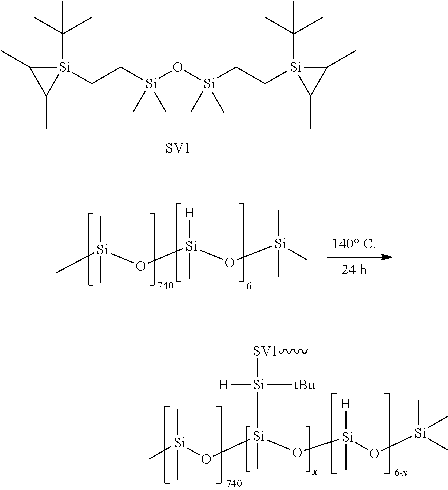

SV1 (87.5 mg, 185.6 μmol, 10.0 equivalents) and silicone oil (1.03 g, 18.58 μmol, 1.0 equivalent, 55.000 g/mol, (0.5-1% methylhydridosiloxane-dimethylsiloxane copolymer, TMS terminated)) are weighed out in a molar ratio of 20:6 (Silirane groups to Si—H groups) under inert gas into a suitable vessel. The mixture is stirred with a magnetic stirring bar until homogeneous mixing is ensured. Crosslinking takes place at 140° C. under inert gas for 24 hours. The product is a white, opaque and elastic polymer which is not sticky. The polymer swells significantly in benzene and does not dissolve. No soluble constituents were detectable by NMR spectroscopy.

### Use Example 6: Crosslinking of 2,4,6,8-Tetramethylcyclotetrasiloxan (TMCTS) with SV1

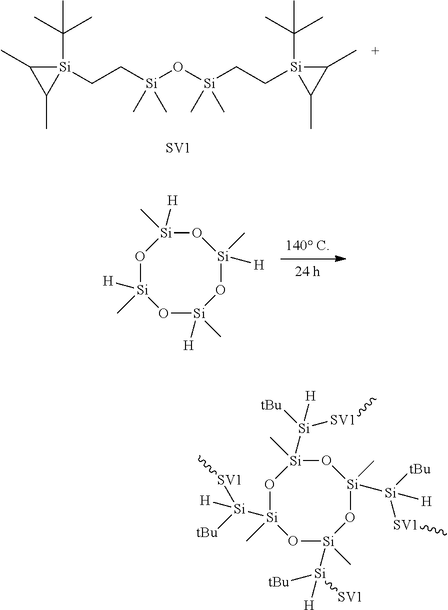

SV1 (100 mg, 212.3 μmol, 1.0 equivalent) and the cyclic siloxane TMCTS (23 mg, 95.53 μmol, 0.45 equivalent, 2,4,6,8-tetramethylcyclotetrasiloxane) are weighed out in a molar ratio of 1:0.9 (silirane groups to Si—H groups) under inert gas into a suitable vessel. The mixture is stirred with a magnetic stirring bar until homogeneous mixing is ensured. Crosslinking takes place at 140° C. under inert gas in a closed system for 24 hours. The resultant product is a solid, transparent polymer which is not sticky and has slightly elastic properties. The polymer swells significantly in benzene, without dissolving. No soluble constituents were detectable by NMR spectroscopy.

### Use Example 7: Crosslinking of Short-Chain OH-Terminated Polydimethylsiloxane with SV1

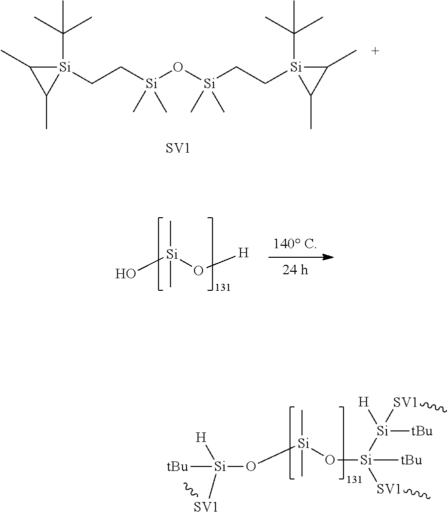

SV1 (50 mg, 106.2 μmol, 1.0 equivalent) and silicone oil (1.03 g, 106.2 μmol, 1.0 equivalent, 9.750 g/mol, polydimethylsiloxane, OH-terminated) are weighed out in a molar ratio of 1:1 (silirane groups to Si—OH groups) under inert gas into a suitable vessel. The mixture is stirred with a magnetic stirring bar until homogeneous mixing is ensured. Crosslinking takes place at 140° C. under inert gas for 24 hours. The resulting polymer is colorless, slightly turbid, not sticky, and exhibits elastic properties.

### Use Example 8: Crosslinking of Short-Chain OH-Terminated Polydimethylsiloxane with SV3

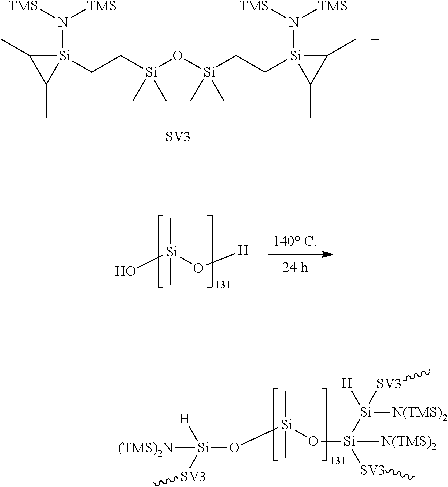

SV3 (50 mg, 73.79 μmol, 1.0 equivalent) and silicone oil (721 mg, 73.79 μmol, 1.0 equivalent, 9.750 g/mol, polydimethylsiloxane, OH-terminated) are weighed out in a molar ratio of 1:1 (silirane groups to Si—OH groups) under inert gas into a suitable vessel. The mixture is stirred with a magnetic stirring bar until homogeneous mixing is ensured. Crosslinking takes place at 140° C. under inert gas for 24 hours. The resulting product is a colorless, slightly turbid, elastic polymer. There is severe swelling of the polymer in benzene, without it dissolving. No soluble constituents were detectable by NMR spectroscopy. Alternatively molar mixing ratios of 0.5:1 (silirane groups to Si—OH groups) and 2:1 (silirane groups to Si—OH groups) are used in accordance with an analogous procedure. In the former case, colorless, clear, very soft and sticky elastomers are obtained. In the case of the superstoichiometric addition of the crosslinker, a colorless, turbid polymer is obtained which has elastic properties. The polymer obtained is softer by comparison with the 1:1 mixture.

### Use Example 9: Crosslinking of Long-Chain OH-Terminated Polydimethylsilane with SV1

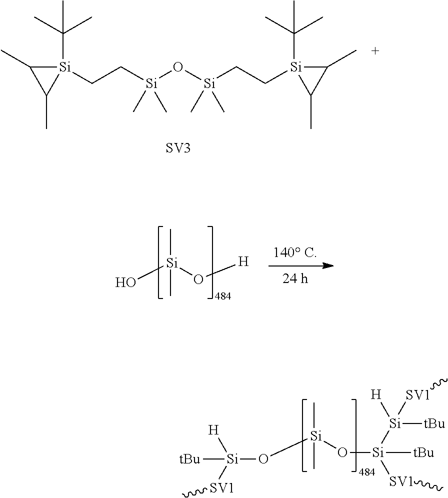

SV1 (34 mg, 73.8 μmol, 1.0 equivalent) and silicone oil (67 mg, 73.8 μmol, 1.0 equivalent, 36.000 g/mol, polydimethylsiloxane, OH-terminated) are weighed out in a molar ratio of 1:1 (silirane groups to Si—OH groups) under inert gas into a suitable vessel. The mixture is stirred with a magnetic stirring bar until homogeneous mixing is ensured. Crosslinking takes place at 140° C. under inert gas for 24 hours. The result is a turbid, soft and elastic polymer. Because of the longer chains by comparison with use example 7, the polymer network is more flexible, providing a possible explanation for the lower strength of the resultant elastomer. There is severe swelling of the polymer in benzene, without being dissolved. No soluble constituents were detectable by NMR spectroscopy.

### Use Example 10: Crosslinking of Long-Chain OH-Terminated Polydimethylsilane with SV3

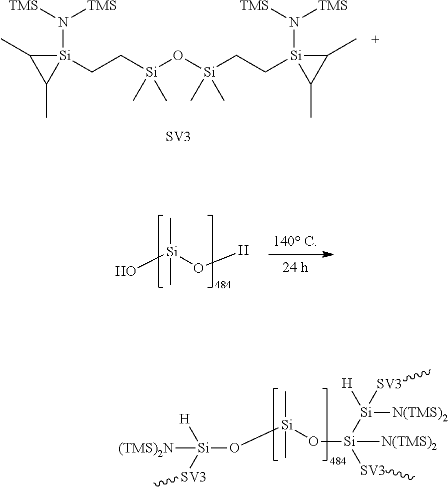

SV3 (50 mg, 73.8 μmol, 1.0 equivalent) and silicone oil (67 mg, 73.8 μmol, 1.0 equivalent, 36.000 g/mol, polydimethylsiloxane, OH-terminated) are weighed out in a molar ratio of 1:1 (silirane groups to Si—OH groups) under inert gas into a suitable vessel. The mixture is stirred with a magnetic stirring bar until homogeneous mixing is ensured. Crosslinking takes place at 140° C. under inert gas for 24 hours. The resulting polymer is a clear, colorless, nonsticky elastomer. There is severe swelling of the polymer by addition of benzene, but without the polymer dissolving. No soluble constituents were detectable by NMR spectroscopy.

1-12. (canceled)

13. Silirane-functionalized compounds consisting of a substrate on which at least two silirane groups of the formula (I) 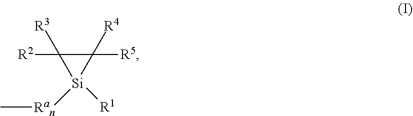
are covalently bonded,
where in formula (I) the index n adopts a value of 0 or 1;
and where the radical R^{a} is a divalent C₁-C₂₀ hydrocarbon radical;
and where the radical R¹ is selected from the group consisting of (i) C₁-C₂₀ hydrocarbon radical, (ii) C₁-C₂₀ hydrocarbonoxy radical, (iii) silyl radical —SiR^{a}R^{b}R^{c}, in which the radicals R^{a},R^{b},R^{c} independently of one another are selected from the group consisting of C₁-C₆ hydrocarbon radical, (iv) amine radical —NR^{x}₂, in which the radicals R^{x} independently of one another are selected from the group consisting of (iv.i) hydrogen, (iv.ii) C₁-C₂₀ hydrocarbon radical, and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; and
where the radicals R²,R³,R⁴,R⁵ independently of one another are selected from the group consisting of (i) hydrogen, (ii) halogen, and (iii) C₁-C₂₀ hydrocarbon radical, in which the radicals R² and R⁴ may also be part of a cyclic radical,
where the compound of the formula 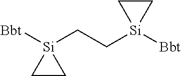
in which Bbt is 2,6-[CH(SiMe₃)₂]-4-[C(SiMe₃)₃]—C₂H₆ is excluded.

14. The silirane-functionalized compounds as claimed in claim 13, characterized in that the substrate is selected from the group consisting of organosilicon compounds, hydrocarbons, silicas, glass, sand, stone, metals, semimetals, metal oxides, mixed metal oxides, and carbon-based oligomers and polymers.

15. The silirane-functionalized compounds as claimed in claim 14, characterized in that the substrate is selected from the group consisting of silanes, siloxanes, precipitated silica, fumed silica, glass, hydrocarbons, polyolefins, acrylates, polyacrylates, polyvinyl acetates, polyurethanes and polyethers composed of propylene oxide and/or ethylene oxide units.

16. The silirane-functionalized compounds as claimed in claim 13, characterized in that they are silirane-functionalized organosilicon compounds selected from the group consisting of compounds of the general formula (II)
(SiO_{4/2})ₐ(R^{x}SiO_{3/2})_{b}(R′SiO_{3/2})_{b′}(R^{x}₂SiO_{2/2})_{c}(R^{x}R′SiO_{2/2})_{c′}(R′₂SiO_{2/2})_{c″}(R^{x}₃SiO_{1/2})_{d}(R′R^{x}₂SiO_{1/2})_{d′}(R′₂R^{x}SiO_{1/2})_{d″}(R′₃SiO_{1/2})_{d″′} (II),
in which the radicals R^{x} independently of one another are selected from the group consisting of (i) hydrogen, (ii) halogen, (iii) unsubstituted or substituted C₁-C₂₀ hydrocarbon radical and (iv) unsubstituted or substituted C₁-C₂₀ hydrocarbonoxy radical;
and in which the indices a, b, b′, c, c′, c″, d, d′, d″, d″′ indicate the number of the respective siloxane unit in the compound and independently of one another are an integer in the range from 0 to 100 000, with the proviso that the sum of a, b, b′, c, c′, c″, d, d′, d″, d′″ together adopts a value of at least 2 and at least one of the indices b′, c′, d′ is ≥2 or at least one of the indices c″, d″ or d″′ is other than 0;
and the radicals R′ are a silirane group of the formula (IIa) 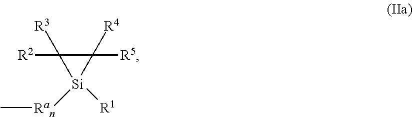
in which the index n adopts a value of 0 or 1; and
in which the radical R^{a} is a divalent C₁-C₂₀ hydrocarbon radical;
and where the radical R¹ is selected from the group consisting of (i) C₁-C₂₀ hydrocarbon radical, (ii) C₁-C₂₀ hydrocarbonoxy radical, (iii) silyl radical —SiR^{a}R^{b}R^{c}, in which the radicals R^{a},R^{b},R^{c} independently of one another are a C₁-C₆ hydrocarbon radical, (iv) amine radical —NR^{x}₂, in which the radicals R^{x} independently of one another are selected from the group consisting of (iv.i) hydrogen, (iv.ii) C₁-C₂₀ hydrocarbon radical, and (iv.iii) silyl radical —SiR^{a}R^{b}R^{c}, in which the radicals R^{a},R^{b},R^{c} independently of one another are a C₁-C₆ hydrocarbon radical, and (v) imine radical —N═CR¹R², in which the radicals R¹,R² independently of one another are selected from the group consisting of (v.i) hydrogen, (v.ii) C₁-C₂₀ hydrocarbon radical and (v.iii) silyl radical —SiR^{a}R^{b}R^{c}, in which the radicals R^{a},R^{b},R^{c} independently of one another are a C₁-C₆ hydrocarbon radical; and
where the radicals R²,R³,R⁴,R⁵ independently of one another are selected from the group consisting of (i) hydrogen, (ii) halogen, and (iii) C₁-C₂₀ hydrocarbon radical, in which the radicals R² and R⁴ may also be part of a cyclic radical.

17. The silirane-functionalized compounds as claimed in claim 16, where in formula (II) the indices a, b, b′, c, c′, c″, d, d″ and d″′ adopt a value of 0 and the index d′ adopts a value of 2; and where in formula (IIa) the index n adopts a value of 1, and the radical R^{a} is a C₁-C₃ alkylene radical, and the radical R¹ is selected from the group consisting of (i) C₁-C₆ hydrocarbon radical and (ii) amine radical —N(SiR^{a}R^{b}R^{c})₂, in which the radicals R^{a},R^{b},R^{c} independently of one another are a C₁-C₆ hydrocarbon radical, and the radicals R²,R³,R⁴,R⁵ independently of one another are selected from the group consisting of (i) hydrogen and (ii) C₁-C₆ alkyl radical, in which the radicals R² and R⁴ may also be part of a cyclic radical.

18. The silirane-functionalized compounds as claimed in claim 17, where in formula (IIa) the radical R^{a} is an ethylene radical; and the radical R¹ is selected from the group consisting of (i) C₁-C₆ alkyl radical and (ii) —N(SiMe₃)₂; and the radicals R²,R³,R⁴,R⁵ independently of one another are selected from the group consisting of (i) hydrogen and (ii) C₁-C₆ alkyl radical, in which the radicals R² and R⁴ may also be part of a hexenyl radical.

19. The silirane-functionalized compounds as claimed in claim 16, which is selected from the following compounds 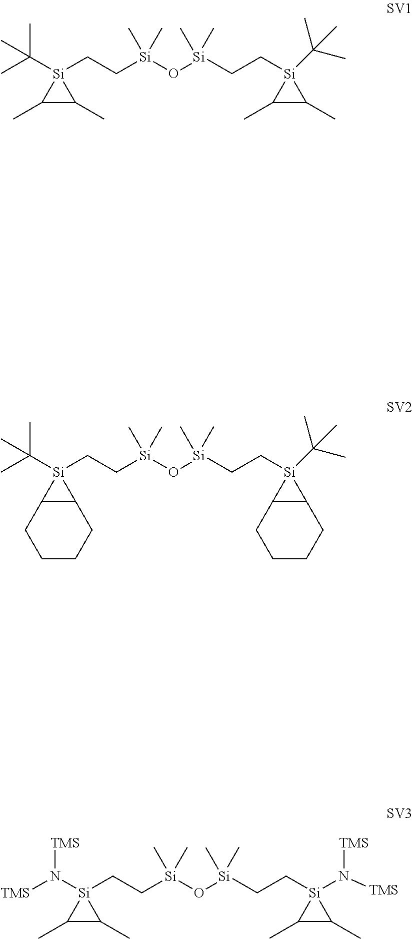
SV1, SV2 and SV3.

20. A mixture comprising
a) at least one silirane-functionalized compound as claimed in any of claims 1-7; and
b) at least one compound A which has in each case at least two radicals R′, where the radicals R′ independently of one another are selected from the group consisting of (i) —Si—H, (ii) —OH, (iii) —CₓH₂ₓ—OH, in which x is an integer in the range of 1-20, (iv) —CₓH₂ₓ—NH₂, in which x is an integer in the range of 1-20, (v) —SH, and (vi) —R^{a}ₙ—CR═CR₂, in which R^{a} is a divalent C₁-C₂₀ hydrocarbon radical and the index n adopts a value of 0 or 1 and the radicals R independently of one another are selected from the group consisting of (vi.i) hydrogen and (vi.ii) C₁-C₆ hydrocarbon radical.

21. The mixture as claimed in claim 20, where the compound A is selected from functionalized siloxanes of the general formula (III)
(SiO_{4/2})ₐ(R^{x}SiO_{3/2})_{b}(R′SiO_{3/2})_{b′}(R^{x}₂SiO_{2/2})_{c}(R^{x}R′SiO_{2/2})_{c′}(R′₂SiO_{2/2})_{c″}(R^{x}₃SiO_{1/2})_{d}(R′R^{x}₂SiO_{1/2})_{d′}(R′₂R^{x}SiO_{1/2})_{d″}(R′₃SiO_{1/2})_{d″′} (III),
in which the radicals R^{x} independently of one another are selected from the group consisting of (i) halogen, and (ii) unsubstituted or substituted C₁-C₂₀ hydrocarbon radical; and
in which the radicals R′ independently of one another are selected from the group consisting of (i) hydrogen, (ii) —OH, (iii) —CₓH₂ₓ—OH, in which x is an integer in the range of 1-20, (iv) —CₓH₂ₓ—NH₂, in which x is an integer in the range of 1-20, (v) —SH, and (vi) —R^{a}ₙ—CR═CR₂, in which R^{a} is a divalent C₁-C₂₀ hydrocarbon radical and the index n adopts a value of 0 or 1 and the radicals R independently of one another are selected from the group consisting of (vi.i) hydrogen and (vi.ii) C₁-C₆ hydrocarbon radical; and
in which the indices a, b, b′, c, c′, c″, d, d′, d″, d″′ indicate the number of the respective siloxane unit in the compound and independently of one another are an integer in the range from 0 to 100 000, with the proviso that the sum of a, b, b′, c, c′, c″, d, d′, d″, d″′ together adopts a value of at least 2 and at least one of the indices b′, c′, d′ is ≥2 or at least one of the indices c″, d″ or d′″ is other than 0.

22. A process for preparing siloxanes, comprising the following steps:
(i) providing a mixture as claimed in claim 21, and
(ii) reacting the mixture by thermal, photochemical or catalytic activation.

23. The process as claimed in claim 22, where the activation takes place thermally and the temperature is in a range from 60° C. to 200° C.

24. The process as claimed in claim 22, where the molar ratio of silirane groups to functional groups in the siloxane is in a range of 4:1-1:4.
